(19) United States
(12) Patent Application Publication
(10) Pub. No.: US 2016/0144315 A1
(43) Pub. Date: May 26, 2016

(54) METHOD AND DEVICE FOR PURIFYING EXHAUST AIR PRODUCED DURING WOOD PROCESSING

(71) Applicant: KRONOPLUS TECHNICAL AG, Niederteufen (CH)

(72) Inventors: Hermann MUSS, Neukirchen/V. (AT); Robert WEINBERGER, Ried im Innkreis (AT); Emst NEUHUBER, Neukirchen/V (AT)

(73) Assignee: Kronoplus Technical AG, Niederteufen (CH)

(21) Appl. No.: 14/905,551

(22) PCT Filed: Apr. 16, 2014
(86) PCT No.: PCT/EP2014/057692

§ 371 Date: Jan. 15, 2016

(30) Foreign Application Priority Data
Jul. 18, 2013 (EP) 13176955.6

(51) Int. Cl. B01D 53/14; B03C 3/16; B03C 3/017; B01D 53/18; B01D 47/00

(52) U.S. Cl. CPC B01D 53/1425; B01D 53/1487; B01D 53/18; B01D 47/00; B03C 3/017; B03C 3/16

(57) ABSTRACT

A device for the purification of exhaust air produced during the processing of wood materials comprises a first circuit (A) having a scrubber (2), a mist eliminator (4) and a regeneration container (7). In order to strip the washing liquid from organic substances, a second circuit (B) is provided and serves to remove a sub-stream of the washing liquid from the first circuit (A) and supply it to a desorber (12). The washing liquid purified in this way is recirculated to the first circuit (A).

### TECHNICAL FIELD

The present invention relates to a method and a device for purifying exhaust air, such as that produced in the processing of wood materials, for example. The method and the device are suitable in particular for purifying exhaust air in the production of particle board, OSB, MDF, HDF, HPL and CPL in a continuous press or by a dryer. The method and the device are suitable in particular for removing dust, formaldehyde, formic acid and acetic acid from exhaust air, for example exhaust air from the actual press or exhaust air from a dryer.

### PRIOR ART

DE 42 12 164 C2 describes a method and a device for purifying exhaust air from a press. The device has a modular unit, which draws in gases and vapors. These gases and vapors are then purified by means of a scrubbing liquid and sent to a droplet separator. The exhaust air stream purified in this way is separated from the contaminated scrubbing liquid in the droplet separator and flows through an exhaust fan into a vent stack. The scrubbing liquid loaded with contaminants passes through a return line into a reprocessing pond. There, heavy substances are discharged with a sediment scraper (sedimentation) and light substances are discharged via a floating layer of sludge (flotation). The scrubbing liquid from the reprocessing pond is then sprayed again into the exhaust air in a closed circulation.

However, the method disclosed in DE 42 12 164 C2 has the disadvantage that the scrubbing liquid is constantly being enriched with soluble organic substances such as formaldehyde, for example, as a result of the circulation, and, after a certain operating time, the scrubbing liquid must be replaced completely and then discarded. Another serious disadvantage derives from the fact that scrubbing of the exhaust air with the scrubbing liquid becomes progressively less efficient, the longer the scrubbing liquid is enriched with soluble contaminants.

DE 101 00 895 C2, DE 101 00 896 C1 and EP 2 522 415 A1 also describe systems having an essentially closed circulation of scrubbing liquid.

Scrubbing liquid from such systems can be aftertreated chemically to maintain the scrubbing performance through degradation and/or removal of the organic substances. This can be accomplished by adding additives for binding the organic substances or else by chemicals for achieving chemical reactions such as the Canizzaro reaction, for example, for degradation of formaldehyde by a chemical method. Another method is also a biological treatment of the circulating water to reduce the organic pollutant burden and thus to maintain the scrubbing performance. One important disadvantage of systems that attempt the requisite purification of wastewater by means of chemical reactions is the high use of chemicals and the reaction time required for the reaction.

Biological aftertreatment methods are one alternative to chemical aftertreatment methods. An arrangement based on flotation and biological purification is described in EP 0358006 A1, for example. WO 92/00792 A1 discloses a method in which a portion of the scrubbing liquid is removed from the closed scrubbing circulation and conducted through a biological aftertreatment unit to decompose organic pollutants before the scrubbing liquid is recirculated to the closed circulation.

However, biological systems cannot be turned off and on in the sense of technical systems and therefore have weaknesses with changes in the type of wood and/or with a change in the load of the upstream presses and dryers. They are also very expensive to acquire and operate.

DE 36 35 934 C2 discloses a purification method in which the exhaust air is sprayed with a scrubbing liquid that has been enriched with microorganisms and then passed through an electrical high-voltage field.

It is proposed in DE 38 35 161 C2 that oxidizable compounds from process exhaust gases be oxidized by means of a wet chemical catalytic circulating process using atmospheric oxygen in aqueous solution. However, this requires catalysts, which may be problematical for the environment. This document discusses additional exhaust air purification methods, including thermal aftertreatment (incineration). This has the disadvantage that the operating costs are very high when large amounts of gas having a low pollutant content must be reacted at high temperatures, as is usually the case with exhaust air from wood processing.

U.S. Pat. No. 5,378,267 discloses a system for removing organic contaminants from water, in which air is passed through the water.

### SUMMARY OF THE INVENTION

One object of the present invention is to make available an energy-efficient, effective and inexpensive device as well as such a method for purifying exhaust air in the wood materials industry.

This object is achieved by a method as claimed in claim 1 and a device as claimed in claim 11, respectively.

Advantageous developments of the invention are defined in the dependent claims.

A method is thus specified for purifying exhaust air, in particular exhaust air from the processing of wood materials, for example from a press or a dryer. This method comprises a first circulation with the following steps:
scrubbing the exhaust air with a scrubbing liquid, preferably with a water-based scrubbing liquid;
separating the exhaust air and the scrubbing liquid;
removing solids from the scrubbing liquid; and
recirculating the scrubbing liquid for scrubbing the exhaust air.

To remove organic substances, in particular volatile and water-soluble organic substances, such as formaldehyde, formic acid and/or acetic acid, from the scrubbing liquid, at least a substream of the scrubbing liquid is withdrawn from the first circulation and fed to a second circulation. The scrubbing liquid is at least partially recirculated to the first circulation again after removal of the organic substances.

Thus, the exhaust air is first detected, collected and subjected to a dust separation and to absorption of the organic substances, such as formaldehyde, formic acid and acetic acid, in a scrubber using a scrubbing liquid. Then the scrubbing liquid is separated from the exhaust air gas stream, for example in a vortex sink separator (cyclone) or in a wet electrostatic filter. The gas stream purified in this way can then be discharged directly to the surroundings or diverted through additional filter measures or soundproofing measures, for example through a chimney stack. The loaded scrubbing liquid can be collected in a reprocessing container, for example. There, it can be purified of solids, such as particulate matter and sludge, and fed back to the scrubber. Other measures for separating solids are also conceivable. According to the invention, at least a substream of the scrubbing liquid is branched off from this first circulation and sent for further processing to remove volatile organic compounds (VOCs). The scrubbing liquid is then at least partially returned back to the first circulation.

If a wet electrostatic filter is used, the scrubber may also be integrated into it.

The organic substances are removed with the help of a desorber, in particular a so-called column desorber. The organic substances are removed (“stripped”) from the scrubbing liquid in the desorber by a stripping gas which is carried in co-current or countercurrent with the scrubbing liquid. At the same time, the stripping gas is loaded with the organic substances accordingly. The stripping gas is preferably air. But it may also be another gas, for example air to which nitrogen has been added to reduce the risk of explosion. The desorber may be designed, for example, as a spray desorber or as a packed desorber with a suitable packing, for example with a packing of steel beads or ceramic parts, as is known per se from the prior art. However, the desorber may also be designed as a plate column. Combinations of plate columns, spray desorbers and packed desorbers are also possible.

The process parameters, in particular the stripping gas, which is carried in co-current or countercurrent, are preferably adjusted so that, after leaving the desorber, the loaded stripping gas has a higher concentration of organic substances than the exhaust air, preferably a concentration at least five times higher. An increase in concentration by a factor of more than 10 or even 20 is possible. On the whole, the organic substances are thus concentrated in this way. Thus, only a much smaller amount of gas need be fed to an incineration than the total amount of exhaust air from the press or from a dryer. Therefore, a thermal aftertreatment and/or incineration of the organic substances with a much lower energy expenditure and with a higher efficiency is/are possible.

The process parameters can be adjusted on the basis of the following considerations: the temperature of the scrubbing liquid on entering the desorber is adjusted suitably, depending on the organic pollutant to be diminished. In practice, a scrubbing liquid inlet temperature of 80° C. often leads to an approximately 5- to 10-fold increase in the concentration of organic substances in the loaded stripping gas in comparison with the exhaust air. The inlet temperature of the scrubbing liquid on entering the desorber should be at least approximately 20-25° C. higher relative to the exhaust air to be purified. With an increase in the temperature difference between the exhaust air to be purified and the inlet temperature of the scrubbing liquid at the desorber, the concentration of organic pollutants in the desorber exhaust air increases with the same amount of stripping air, depending on the respective vapor pressure of the organic substance. For economic reasons, a further increase is no longer viable at a temperature just below 100° C., because water begins to evaporate at 100° C., and the required heat of evaporation is very high.

The stripping gas is preferably preheated before being loaded with the organic substances in the desorber. A distinct increase in the loading of the stripping gas can be achieved in this way. A portion of the preheated unloaded stripping gas or additional preheated gas may be mixed with the loaded stripping gas during or after leaving the desorber to reduce the water vapor concentration of the loaded stripping gas. This prevents unwanted condensation of water occurring in the downstream pipelines.

The scrubbing liquid is advantageously also heated before entering the desorber. To improve the energy efficiency, it is advantageous if the scrubbing liquid, before entering the desorber, is brought into thermal contact in a heat exchanger with the scrubbing liquid leaving the desorber, to heat the scrubbing liquid fed to the desorber and to cool the scrubbing liquid leaving the desorber. A substantial amount of energy is saved and/or recovered through this heat shift system. The scrubbing liquid can be heated with additional energy in a further heat exchanger.

Before that, the scrubbing liquid branched off from the first circulation may optionally be pretreated to reduce unwanted deposits in the heat exchangers and in the desorber. For example, the solids load can be further diminished by a hydrocyclone.

However, it has been found that, despite careful pretreatment of the scrubbing liquid, the heat exchangers become contaminated over time by fine shavings, fibers, paraffins, etc. and then operate less efficiently. It is therefore proposed that at least a portion of the second circulation be rinsed periodically with a rinsing liquid. The rinsing liquid may be water in particular or a water-based liquid. The rinsing liquid is preferably heated for this purpose. The flow rate of the rinsing liquid is preferably set higher than the flow rate of the scrubbing liquid during normal operation. The rinsing liquid preferably flows through at least a portion of the second circulation in the opposite direction from that in normal operation.

Furthermore, a device for purifying exhaust air is specified. It has a first circulation, comprising at least the following elements:

a scrubber for scrubbing the exhaust air with a scrubbing liquid;

a droplet separator (for example, a vortex sink separator) to separate the exhaust air and the scrubbing liquid after scrubbing;

a reprocessing container (for example, a pond) to collect the separated scrubbing liquid and to remove solids from the scrubbing liquid; and

a feed device to return the scrubbing liquid from the reprocessing container to the scrubber.

The device also comprises a second circulation, comprising at least the following elements:

a withdrawal line to withdraw at least a substream of the scrubbing liquid from the first circulation;

a desorber, in particular a column desorber, for removing organic substances from the scrubbing liquid withdrawn in co-current or countercurrent using a stripping gas; and

a recirculation line for returning the scrubbing liquid at least partially to the first circulation after removal of the organic substances.

The same considerations apply accordingly to the device as to the method summarized above.

The second circulation in particular may have a heat exchanger to preheat the stripping gas before it is loaded with the organic substances in the desorber, as described above.

Furthermore, a bypass device may be provided to mix a portion of the preheated unloaded stripping gas with the loaded stripping gas during or after leaving the desorber and to thereby reduce the water vapor concentration in the stripping gas, as described above.

A heat exchanger having a first side and a second side, which is in thermal contact with the first side, may be provided, wherein the scrubbing liquid fed to the desorber is conducted through the first side, and wherein the scrubbing liquid leaving the desorber is conducted through the second side. The scrubbing liquid fed to the desorber can therefore be heated, and the scrubbing liquid leaving the desorber can be cooled, as described above.

The device may comprise a rinsing liquid feed and shut-off elements to rinse at least a portion of the second circulation with a rinsing liquid, as described above. The device may also have a heat exchanger to heat the rinsing liquid, as also already discussed above.

The device may have means for feeding the stripping gas to a thermal aftertreatment or incineration after leaving the desorber. A burner may be connected downstream from the device to receive and incinerate the loaded stripping gas.

### BRIEF DESCRIPTION OF THE DRAWING

Preferred embodiments of the invention are described in the following on the basis of the drawing, which serves merely for illustration and is not to be interpreted restrictively. The drawing shows:

FIG. 1 a system for purifying the exhaust air of a press for wood materials according to a first exemplary embodiment of the invention;

FIG. 2 a system for purifying the exhaust air of a dryer for wood materials according to a second exemplary embodiment of the invention.

### DESCRIPTION OF PREFERRED EMBODIMENTS

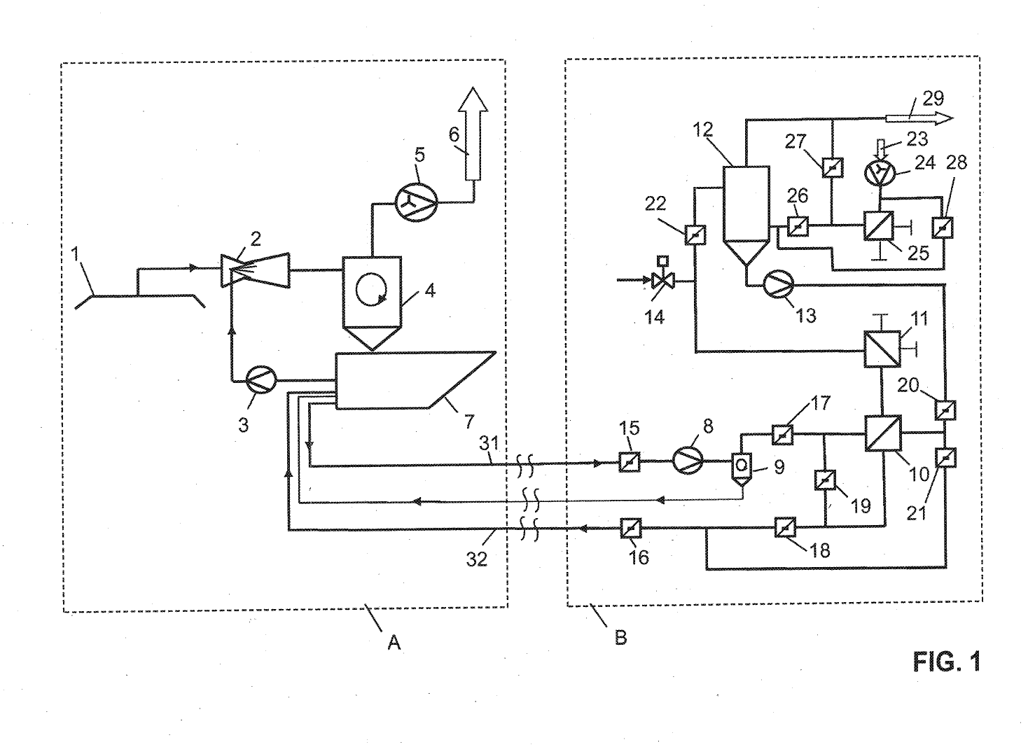

FIG. 1 shows a system for purifying the exhaust air of a press for wood materials according to a first exemplary embodiment of the invention. The system consists of two circuits A and B, which may be separated spatially from one another.

Circuit A forms an exhaust air scrubbing circuit. It comprises an exhaust device 1, with which exhaust air is exhausted out of the press and collected. From there, the exhaust air passes as a gas stream into an absorber or scrubber 2. This may be a venturi scrubber, but other embodiments are also possible, for example a spray jet scrubber, an eddy current wet separator or a falling-film filter. In scrubber 2, the gas stream is brought into contact with a scrubbing liquid to achieve separation of dust and other solid and liquid components as well as absorption of gaseous components out of the gas stream. The scrubbing liquid is preferably water, which may optionally be provided with essentially known additives, such as surfactants and pH buffers, for example, to reduce the surface tension, to improve the solubility for organic compounds (in particular VOCs) and/or to keep the scrubbing liquid in a desired pH range.

The scrubbing liquid and the purified exhaust air are separated again after the scrubbing operation in a liquid droplet separator 4, which may be designed as a vortex sink separator, for example. The gas stream can then be diverted directly to the surroundings via a fan 5 and a vent stack 6 or treated further as needed through additional units, such as a fine droplet separator, for example, before being diverted.

The scrubbing liquid is collected in a reprocessing pond 7 and is purified there to remove solids and then fed back to the scrubber 2 via a circulating pump 3.

A substream from circuit A is branched off from the reprocessing pond 7 via a withdrawal line 31 and is fed by means of a feed pump 8 to the second circuit B for further processing. Any residual solids still present are separated off there first via a vortex sink separator (hydrocyclone) 9 and returned to the reprocessing pond 7 or collected separately. The scrubbing liquid pre-purified in this way is then preheated in a heat exchanger 10, which may be designed as a free-flow plate heat exchanger, for example. This is done with the liquid return flow of the column desorber 12, which is described in greater detail below.

In a further heat exchanger 11 which may in turn be designed as a free-flow plate heat exchanger, the liquid is then raised to the required temperature level, preferably 80-95° C., with additional energy and conducted into the column desorber 12.

The column desorber (stripper) 12 may be designed, for example, as a spray desorber or as a packed desorber, as a plate column or as a combination of a spray desorber and/or a packed desorber and/or a plate column. The choice of the type of column desorber is usually made depending on the degree of soiling (soiling can be introduced into the system through the liquid to be purified and/or the stripping air) and/or depending on the purification interval still accepted (manual purification in most cases) for the desorber. The spray desorber is the least sensitive to soiling but unfortunately has the smallest mass exchange surface area with the same space requirement (specific mass exchange surface area) of all designs for desorption. The spray desorber is therefore usually combined with a packed column or a plate column, wherein the nozzle also ensures uniform sprinkling of the packing and/or of the first plate. It can also be stated in general that plate columns will be less sensitive to soiling than packed columns but will also have a lower specific mass exchange surface area than the latter. The choice of the column design and/or the most appropriate combination therefore depends essentially on the respective operating parameters, in particular the soiling over the operating time.

A gas stream, an air stream 23 here, which is preheated by a further heat exchanger 25 before being blown into the column desorber 12, is fed to the column desorber 12 by a fan 24. The volume flows of preheated air and unpreheated air can be adjusted separately by means of a bypass adjusting valve 28, which bridges the heat exchanger 25, and a further adjusting valve 26, which is connected downstream from the heat exchanger 25. The air stream is blown into the column desorber 12 in countercurrent with the scrubbing liquid. Organic compounds, in particular VOCs, are therefore removed from (stripped out of) the scrubbing liquid and picked up by the air stream. The air stream leaves the column desorber as an exhaust air stream 29. The contaminated exhaust air can be fed without any additional expense to a thermal aftertreatment and/or incineration, in which the organic substances are destroyed thermally.

The scrubbing liquid treated and purified in this way is fed by means of a recirculating pump 13 to the heat exchanger 10, where it releases most of its latent heat to the scrubbing liquid, which is yet to be purified, before the latter is fed to the column desorber 12. The scrubbing liquid cooled in this way is conducted back into the reprocessing pond 7 via a recirculation line 32.

In addition, a substream of the air stream 23 heated in the heat exchanger 25 can be added to the exhaust air stream 29 of the column desorber 12 via an adjusting valve 27 to adjust the dew point of the exhaust air such that no condensation occurs in the downstream pipelines.

Circuit B can be rinsed periodically to remove contaminants originating from e.g., very fine shavings, fibers, nonvolatile organic substances, such as paraffins or the like, from circuit B. To that end, a rinsing liquid feed, in the form of a fresh water valve 14 here, and shut-off elements in the form of valves 15-22 are provided to conduct a rinsing liquid (fresh water here) through the heat exchangers 10, 11 and the pipelines at an elevated flow rate. The fresh water can be preheated by the heat exchanger 11.

In the present exemplary embodiment, the fresh water valve 14 opens into the line from the second heat exchanger 11 to the column desorber 12. To rinse both sides of the heat exchanger 10, for example, a valve 22 between the fresh water valve 14 and the column desorber 12 is closed. A valve 17 at the outlet of the hydrocyclone 9 is closed to prevent rinse water from penetrating into the hydrocyclone. A valve 15 at the inlet of the hydrocyclone and a valve 20 at the outlet of the recirculating pump 13 are also closed. A valve 18 between the outlet of the second side of the heat exchanger 10, at which the purified scrubbing liquid is normally returned to the reprocessing pond 7, and the reprocessing pond 7 is also closed. A bypass valve 19 between the inlet of the first side of the heat exchanger 10, to which the scrubbing liquid to be heated is normally fed, and the outlet of the second side of the heat exchanger 10 is opened. In this way, rinse water can first flow through the heat exchanger 11, opposite the normal direction of flow, then through the first side of the heat exchanger 10 and next through the second side of the heat exchanger 10 opposite the normal direction of flow. The rinse water passes from the second side of the heat exchanger 10, through opened valves 21 and 16, into the reprocessing pond 7.

The column desorber 12 can also be rinsed as needed. To do so, the valves 15, 17, 18 and 19 are closed, and the valves 16, 20, 21 and 22 are opened. Rinse water can then flow from the fresh water valve 14, through the opened valve 22, into the column desorber and leave the latter via the pump 13 and the opened valves 20, 21 and 16 in the direction of the reprocessing pond 7.

Other valve arrangements may of course be selected and the fresh water valve can open into circuit B at another location. Rinsing liquids other than water may also be used. Instead of originating from a press, the exhaust air may also originate from different sources from wood processing, for example from a dryer.

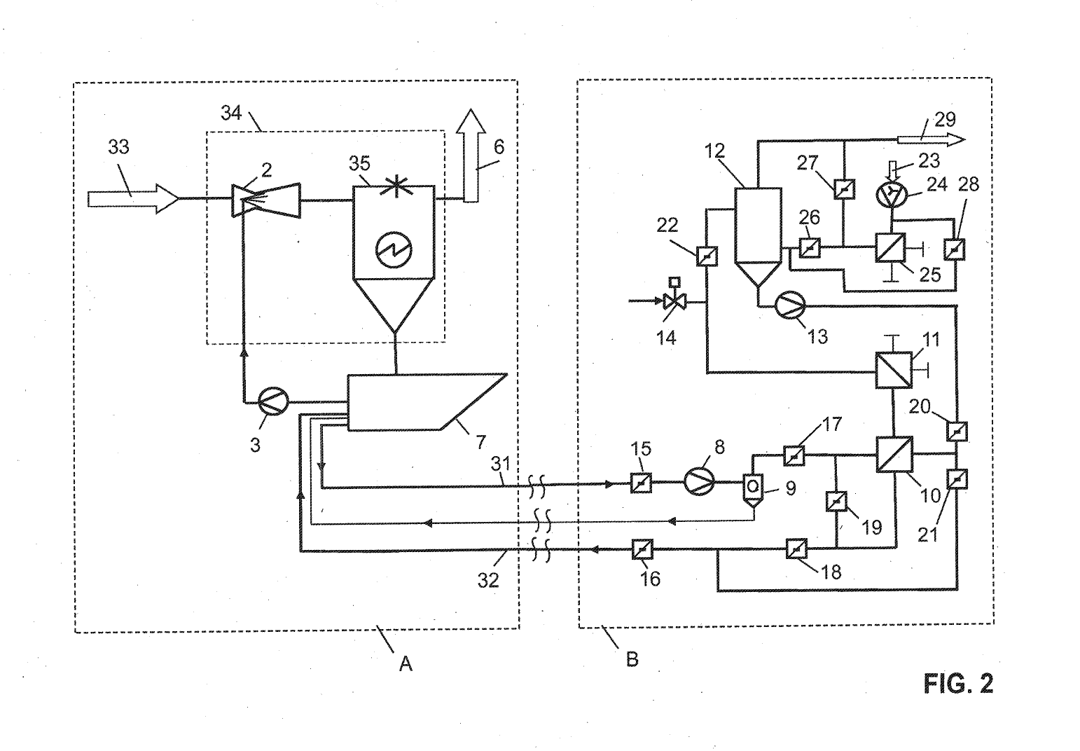

FIG. 2 shows a system for purifying exhaust air from wood processing according to a second exemplary embodiment of the invention. The basic design of this system is very similar to the design of the system in FIG. 1. The same elements of this system or those having the same effect are provided with the same reference numerals as in FIG. 1.

An exhaust air stream 33 from a dryer or a press, for example, passes first, as in the first exemplary embodiment, into a scrubber 2, which may be designed as a venturi scrubber, as in the first exemplary embodiment, for example. The scrubbing liquid and the purified exhaust air are separated again in a wet electrostatic filter 34 after the scrubbing operation. The scrubber 2 may also be integrated into the wet electrostatic filter; in this case, the unit 35 represents a wet electrostatic filter of any design having an integrated scrubber. The separated exhaust air can then be diverted to the surroundings directly through a vent stack 6, as in the first exemplary embodiment, or may be treated further as needed through additional units, such as a fine droplet separator, for example, before being diverted. The separated scrubbing liquid passes into a reprocessing pond 7, as in the first exemplary embodiment, and is then treated further, as in the first exemplary embodiment.

Wet electrostatic filters (wet electrostatic separators) are often used for purifying exhaust gas streams loaded with sticky and tarry substances. The gas is cooled in a scrubber by spraying scrubbing liquid (circulating water) into it up to the saturation point and then passes into the actual filter inlet. There, it is distributed uniformly over the cross section. Next the gas flows into a high-voltage field with collecting electrodes and emission electrodes (usually arranged centrally). The particles and aerosols in the gas are negatively charged and migrate in the electric field to the collecting electrodes (usually tube bundles or honeycomb bundles). Periodic rinsing ensures that the collection surfaces and emission electrodes remain clean. Wet electrostatic filters are often used where aerosol-solid mixtures must be deposited with a high efficiency. They serve for the deposition of aerosols, fine dusts, resin vapors, “blue haze”, oil mists and odors in particular.

### LIST OF REFERENCE NUMERALS

1 exhaust device
2 scrubber
3 circulating pump
4 liquid droplet separator
5 fan
6 vent stack
7 reprocessing pond
8 feed pump
9 vortex separator
10 heat exchanger
11 heat exchanger
12 column desorber
13 recirculating pump
14 fresh water valve
15-22 shut-off valves
23 air stream
24 fan
25 heat exchanger
26-28 adjusting valves
29 exhaust air stream
31 withdrawal line
32 recirculation line
33 gas stream
34 combined unit
35 wet electrostatic filter

1. A method for purifying exhaust air, in particular exhaust air from the processing of wood materials, comprising a first circulation and a second circulation, wherein the first circulation comprises the following steps:
scrubbing the exhaust air with a scrubbing liquid;
separating the exhaust air and the scrubbing liquid;
removing solids from the scrubbing liquid; and
recirculating the scrubbing liquid for scrubbing the exhaust air,
wherein the second circulation comprises at least the following steps:
feeding the scrubbing liquid to a desorber;
removing organic substances from the scrubbing liquid in the desorber by a stripping gas which is carried in co-current or countercurrent with the scrubbing liquid, wherein the stripping gas is loaded with the organic substances,
wherein at least a substream of the scrubbing liquid is withdrawn from the first circulation and fed to the second circulation, and
wherein organic substances are removed from the scrubbing liquid in the second circulation, and the scrubbing liquid is at least partially recirculated to the first circulation after removal of the organic substances.

2. The method as claimed in claim 1, wherein the exhaust air and the scrubbing liquid are separated in a wet electrostatic filter.

3. The method as claimed in claim 1, wherein the co-current or countercurrent is adjusted such that, after leaving the desorber, the loaded stripping gas has a higher concentration of organic substances than the exhaust air.

4. The method as claimed in claim 1, wherein, after leaving the desorber, the loaded stripping gas is fed to a thermal treatment or incineration.

5. The method as claimed in claim 1, wherein the stripping gas is preheated before being loaded with the organic substances in the desorber.

6. The method as claimed in claim 5, wherein a portion of the preheated unloaded stripping gas is mixed with the loaded stripping gas during or after leaving the desorber to reduce the water vapor concentration of the loaded stripping gas.

7. The method as claimed in claim 1, wherein the scrubbing liquid is heated before entering the desorber.

8. The method as claimed in claim 7, wherein the scrubbing liquid, before entering the desorber, is brought into thermal contact in a heat exchanger with the scrubbing liquid leaving the desorber, to heat the scrubbing liquid fed to the desorber and to cool the scrubbing liquid leaving the desorber.

9. The method as claimed in claim 1, wherein at least a portion of the second circulation is rinsed periodically with a rinsing liquid.

10. The method as claimed in claim 9, wherein the rinsing liquid is heated before rinsing.

11. A device for purifying exhaust air, in particular exhaust air from the processing of wood materials, with a first circulation and a second circulation, wherein the first circulation comprising at least the following elements:
a scrubber for scrubbing the exhaust air with a scrubbing liquid;
a droplet separator to separate the exhaust air and the scrubbing liquid after scrubbing;
a reprocessing container to collect the separated scrubbing liquid and to remove solids from the scrubbing liquid; and
a feed device to return the scrubbing liquid from the reprocessing container to the scrubber, and
wherein the device has a second circulation, comprises at least the following elements:
a withdrawal line to withdraw at least a substream of the scrubbing liquid from the first circulation;
a desorber for removing organic substances from the scrubbing liquid withdrawn, through a stripping gas carried in co-current or countercurrent with the scrubbing liquid; and
a recirculation line for returning the scrubbing liquid at least partially to the first circulation after removal of the organic substances.

12. The device as claimed in claim 11, wherein the droplet separator is designed as a wet electrostatic filter.

13. The device as claimed in claim 11, having a heat exchanger to preheat the stripping gas before it is loaded with the organic substances in the desorber.

14. The device as claimed in claim 13, having a bypass device to mix a portion of the preheated unloaded stripping gas with the loaded stripping gas during or after leaving the desorber.

15. The device as claimed in claim 11, wherein the second circulation comprises a heat exchanger having a first side and a second side, which is in thermal contact with the first side, wherein the scrubbing liquid fed to the desorber is conducted through the first side, and wherein the scrubbing liquid leaving the desorber is conducted through the second side, for heating the scrubbing liquid fed to the desorber and for cooling the scrubbing liquid leaving the desorber.

16. The device as claimed in claim 11, wherein the device comprises at least one of a rinsing liquid feed and shut-off elements to rinse at least a portion of the second circulation with a rinsing liquid.

17. The device as claimed in claim 11, which also has a funnel for feeding the stripping gas to a thermal aftertreatment or incineration after leaving the desorber.

18. The method as claimed in claim 1, wherein the scrubbing liquid is a water-based scrubbing liquid.

19. The method as claimed in claim 1, wherein the desorber is a column desorber.

20. The method as claimed in claim 1, wherein the stripping gas is air.

21. The method as claimed in claim 3, wherein the loaded stripping gas has a concentration at least five times higher than the exhaust air.

22. The method as claimed in claim 9, wherein the rinsing liquid is a water-based rinsing liquid.

23. The device as claimed in claim 11, wherein the desorber is a column desorber.

24. The device as claimed in claim 16, wherein the device has a heat exchanger to heat the rinsing liquid.
